(19) United States
(12) Patent Application Publication
(10) Pub. No.: US 2005/0225431 A1
(43) Pub. Date: Oct. 13, 2005

(54) Apparatus for opening/closing the door

(75) Inventor: Jae-Woo Ha, Incheon Metropolitan City (KR)

Correspondence Address: SALIWANCHIK LLOYD & SALIWANCHIK;A PROFESSIONAL ASSOCIATION, PO BOX 142950, GAINESVILLE, FL, 32614-2950, US

(73) Assignee: Jong-O Kim, Gumi-si (KR)

(21) Appl. No.: 10/506,736

(22) PCT Filed: Mar. 5, 2002
(86) PCT No.: PCT/KR02/00371

§ 371 Date: May 9, 2005

(51) Int. Cl. G06F 7/04

(52) U.S. Cl. 340/5.54; 340/5.26

(57) ABSTRACT

The present invention refers to an apparatus for opening/closing the door according to the determining results whether or not password accords or not, based on the arrangement order and the number of the password. The present invention has a plurality of touch sensor arranged in a character shape. A password is inputted to controller in a character shape using a plurality of touch sensor. The controller enables the door to open according to the determining results whether or not a password inputted to the controller accords with a predetermined password. Hence, the present invention offers a password easy to store using a password of a character shape and provides a more reliable security as the password identification systematizes, by opening/closing the door using a password of character shape.

### TECHNICAL FIELD

The present invention relates to an apparatus for opening/closing a door, and more particularly, to a door opening/closing apparatus in which the validity of password is determined based on arrangement order and number of detection signals detected by a contact sensor to open and close the door.

### BACKGROUND ART

In general, apparatuses for opening/closing a door are installed at the doors of big-sized buildings such as houses, apartments or office hostels to prevent outsiders from passing freely.

As an example of the apparatuses for opening/closing a door, a mechanical apparatus provided with a key and a lock is widely used. However, with the passage of time, the mechanical parts constituting the lock that cooperates with the key get worn or foreign substance is inserted into the lock, so that the mechanical apparatus is not operated normally.

Recently, there is proposed an electronic apparatus for opening/closing a door, which includes an outdoor apparatus provided with 10-keys which allow a user to input a password when opening/closing a door and an indoor apparatus provided with a password for determining validity of the password inputted from the 10-keys to open the door. In the electronic apparatus for opening/closing a door, the indoor apparatus stores a password deliberately and compares the stored password with the password inputted from the 10-keys of the outdoor apparatus. The indoor apparatus finally opens the door if the password inputted from the 10-keys of the outdoor apparatus is valid.

However, in the electronic apparatus for opening/closing a door, the keys used for a password among the 10-keys get worn severely since finger prints remain on the keys used for the password too much as the apparatus has been used long. So, it is difficult to input a password and it becomes easy for others to read the password by watching the 10-keys. This causes security problem for the password. In addition, the 10-keys and the circuit to control them should be made complex.

To overcome this problem, there is proposed a method in which a password is set using a plurality of buttons (keys), that is, numbers, characters or combination of them.

In general, according to the method, if a button is pushed, current flows through a contact point under the button to thereby generate signals, and password is inputted based on these signals. However, in the method, the buttons are frequently pressed when many people use the door to which the method is employed. Accordingly, the combination of the button and the contact point gets worn mechanically as it is used long. Then, the combination of the button and the contact point does not role a switch very well so that on/off operation is not performed normally.

Besides the above-described apparatus for opening/closing a door, there is suggested the apparatuses for opening/closing a door to which an iris recognition system or a fingerprint identification system is applied. However, such apparatuses are very expensive so that their applications are limited to buildings that require special security. It is hardly possible to apply the apparatuses to general dwelling houses and apartments. Also, the management of the apparatuses requires a lot of money since the apparatus must be repaired by experts when it is out of order.

### DISCLOSURE OF THE INVENTION

Accordingly, the present invention is directed to an apparatus for opening/closing a door that substantially obviates one or more of the problems due to limitations and disadvantages of the related art.

An object of the present invention is to provide an apparatus for opening/closing a door, in which a door is opened/closed by determining validity of the password using arrangement order and number of the password.

Another object of the present invention is to provide an apparatus for opening/closing a door, which is provided with a plurality of touch sensors arranged in a character shape and in which a password is inputted in order in a character shape.

A further object of the present invention is to provide a method for opening/closing a door using an apparatus for opening/closing a door, which is provided with a plurality of touch sensors.

Additional features and advantages of the invention will be set forth in the description which follows, and in part will be apparent from the description, or may be learned by practice of the invention. The objectives and other advantages of the invention will be realized and attained by the structure particularly pointed out in the written description and claims thereof as well as the appended drawings.

To achieve these and other advantages and in accordance with the purpose of the present invention, as embodied and broadly described, an apparatus for opening/closing a door according to an embodiment of the present invention comprises: sensing means for sensing a password inputted by a user and outputting a sensing signal; controlling means for determining validity of the password based on the sensing signal and outputting a control signal according to a determining result; and door opening/closing means for opening/closing the door according to the control signal.

In the door opening/closing apparatus, the signal processing means may comprise: a key signal converting section for differentiating the key signal outputted from the controlling means and outputting an impulse signal; a key signal combining section for combining the impulse signal and another impulse signal and outputting a combined signal; and a logic operation section for performing logic operation using the combined key signal so that the sensing signal is outputted normally without any malfunction.

In an aspect of the present invention, the door opening/closing apparatus may comprise: password input start means for releasing a sleep mode before the user inputs the password so that the password is inputted normally; and door opening/closing ascertaining means for ascertaining whether or not the password is set normally after the password is set.

In an aspect of the present invention, the door opening/closing apparatus may comprise: sound output means for reporting to the user acoustically whether or not the password is inputted and set normally; and storage means for storing the set password used to determine whether or not the password is set and inputted by the user normally.

In an aspect of the present invention, the door opening/closing apparatus may comprise: password mode selection means for selecting a mode of the password which the user should input so as to set the password; and electronic door opening/closing means for allowing the user to open and close the door inside the door.

Preferably, the sensing means may comprise: a plurality of touch sensors arranged at predetermined positions, for inputting or setting the password by a user's touch; and a touch detecting section correspondingly connected to the plurality of touch sensors, for sensing a touch of the user and outputting a corresponding sensing signal.

Preferably, the door opening/closing means may comprise: a door opening/closing driving section for driving a driving motor according to the control signal outputted from the controlling means and rotating a link member connected to the driving motor; and a door opening/closing operation section connected to the link member, and slidingly moving in a direction according to a rotation of the link member.

Preferably, the validity of the passwords is determined using arrangement order or number of the passwords.

Preferably, the controlling means comprises a port for determining which touch sensor of a plurality of touch sensors included in the sensing means outputs the sensing signal.

According to another aspect of the present invention, there is provided a method of opening/closing a door. The method comprises the steps of: (a) sensing a password inputted by a user and outputting a sensing signal; (b) determining validity of the password based on the sensing signal and outputting a control signal according to a determining result; and (c) opening the door according to the control signal.

Preferably, the step (a) may comprise the steps of: (a-1) releasing a sleep mode by using password input start means; (a-2) allowing the user to touch a plurality of touch sensors so as to input the password using the plurality of touch sensors arranged at predetermined positions; and (a-3) generating a sensing signal in response to the touch of the plurality of touch sensors.

Preferably, the step (b) may comprise the steps of: (b-1) receiving at least one sensing signal generated when the user touches the touch sensors; (b-2) arranging at least one sensing signal in an input order and generating a password key; (b-3) determining whether or not the password key accords with a previously set password key; and (b-4) when the password key accords with the previously set password key, outputting a control signal for controlling the door.

In an aspect of the present invention, the door opening/closing method may further comprise the step of: (b-5) processing the at least one sensing signal using a key signal so as to prevent the at least one sensing signal from malfunctioning.

Preferably, the step (c) may comprise the steps of: (c-1) driving a driving motor according to the control signal; (c-2) rotating a link member in response to a driving of the driving motor; and (c-3) slidingly moving a door opening/closing operation section connected to the link member in a direction according to a rotation of the link member.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is a perspective view of an apparatus for opening/closing a door according to a preferred embodiment of the present invention;

FIG. 2 is an exploded perspective view of the indoor apparatus shown in FIG. 1;

FIG. 3 illustrates a construction of an apparatus for opening/closing a door according to a preferred embodiment of the present invention;

FIG. 4 illustrates the connection relation of the touch detecting section and the signal processor shown in FIG. 3;

FIG. 5 illustrates the waveforms of the signals outputted from the touch detecting section and the signal processor shown in FIG. 3;

FIG. 6 illustrates the touch detecting section shown in FIG. 3;

FIG. 7 illustrates the key signal converting section shown in FIG. 3;

FIG. 8 is a view illustrating a process of generating waveforms shown in FIG. 7;

FIG. 9 is a circuit configuration of the logic operation section shown in FIG. 3;

FIGS. 10a to 10f illustrate an input order of characters and numbers;

FIG. 11 is a flowchart illustrating a method of registering a password to the apparatus for opening/closing a door according to a preferred embodiment of the present invention; and

FIG. 12 is a flowchart illustrating a method of opening a door using a password that is deliberately set by the apparatus for opening/closing a door according to a preferred embodiment of the present invention.

### BEST MODE FOR CARRYING OUT THE INVENTION

Reference will now be made in detail to the preferred embodiments of the present invention, examples of which are illustrated in the accompanying drawings.

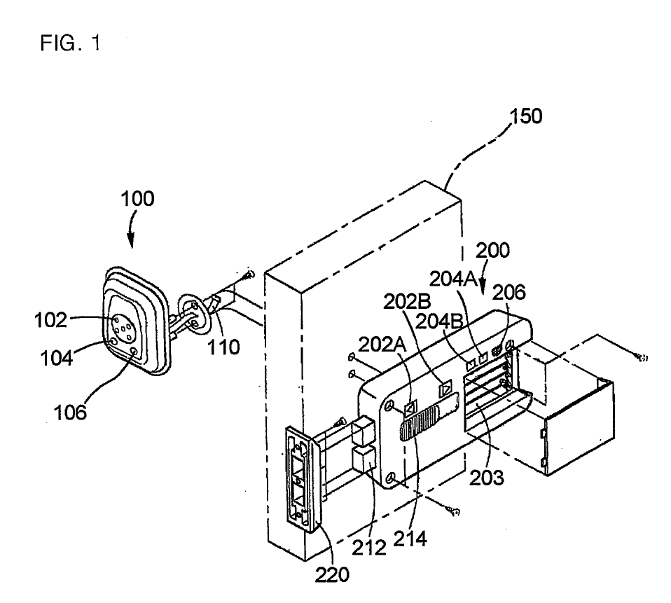

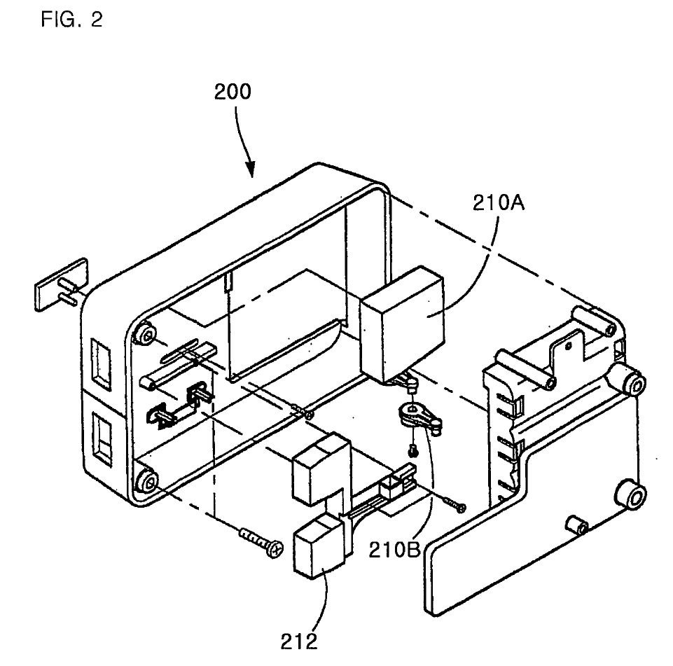

The present invention can be applied especially to the apparatuses for opening/closing a door as shown in FIGS. 1 and 2.

FIG. 1 is a perspective view of an apparatus for opening/closing a door according to a preferred embodiment of the present invention. FIG. 2 is an exploded perspective view of an indoor apparatus shown in FIG. 1. Referring to FIGS. 1 and 2, the apparatus for opening/closing a door according to the present invention includes: an outdoor apparatus 100 installed in a predetermined portion outside a door 150, for inputting a password and providing the inputted password; and an indoor apparatus 200 installed in a predetermined portion inside the door 150 and connected to the outdoor apparatus through a connector 110, for determining validity of the password inputted from the outdoor apparatus 100 to open and close the door 150 according to the determining result.

For the aforementioned operation, the outdoor apparatus 100 includes a plurality of touch sensors 102 for previously setting a password so as to register the password or inputting the password so as to open the door 150.

In addition, the outdoor apparatus 100 includes a password input start button 104 for informing the outdoor apparatus 100 of user's starting to input a password to release a sleep mode so that a battery is saved. Accordingly, the indoor apparatus 200 is in the sleep mode at a normal state. Meanwhile, the sleep mode is released and the battery is activated to supply power as soon as a user presses the password input start button 104.

The outdoor apparatus 100 includes a door opening/closing ascertaining button 106 for ascertaining whether the door is opened or closed. So, the user can easily ascertain whether or not the door is locked by using the door opening/closing ascertaining button 106 although the user goes out.

Even though not shown in FIG. 1, the outdoor apparatus 100 is also provided with means for sensing whether or not a plurality of touch sensors 102 are touched and means for transferring the sensed signal to the indoor apparatus 200.

Meanwhile, the indoor apparatus 200 includes: door opening/closing buttons 202A and 202B for opening/closing the door electronically; password mode selection buttons 204A and 204B for registering a password according to a predetermined condition when registering the password using some characters and/or numbers; a manual door opening/closing member 214 for opening/closing the door forcedly and manually; and a sound member for informing the user of operation states of the apparatus for opening/closing a door acoustically. Also, the indoor apparatus 200 can include: a driving motor 210A for rotating according to a predetermined signal; a link member 210B coupled with a boss that is protruded on one side of the driving motor 210A, for rotating according to operation of the driving motor; and a door opening/closing operation member 212 for opening/closing the door according to rotation of the link member 212. A reference numeral 220, which is not described above, indicates a coupler into which the door opening/closing operation member 212 is inserted/released to thereby open/close the door. Besides, the indoor apparatus 200 can be provided with a power supply (for example, battery) for supplying power to all electronic parts. The indoor apparatus 200 can include an electronic part (not shown) for opening/closing the door by determining the validity of the password based on the sensing signal provided from the outdoor apparatus 100.

The above-described apparatus for opening/closing a door will be explained again in viewpoint of an electronic engineering.

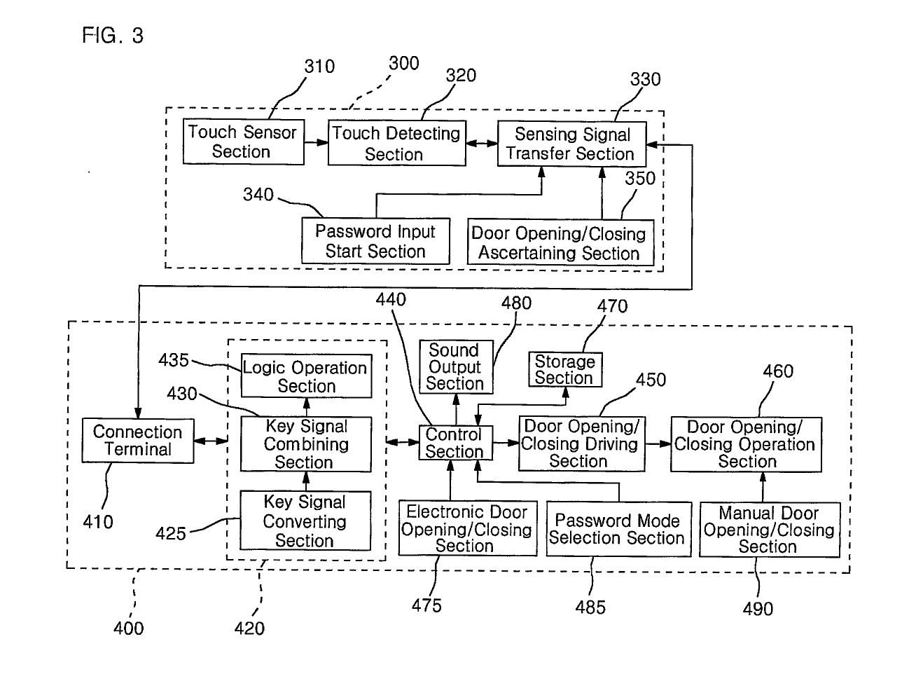

FIG. 3 illustrates a construction of an apparatus for opening/closing a door according to a preferred embodiment of the present invention. Referring to FIG. 3, the apparatus for opening/closing a door according to the present invention includes a password input unit 300 and a door operation unit 400.

The password input unit 300 includes a touch sensor section 310 for inputting a password and a touch detecting section 320 for detecting the password inputted from the touch sensor section 310. Here, the touch sensor section 310 can include five touch sensors. Accordingly, a user can input the desired password using the five touch sensors. The touch sensor 102 is a sensor using static capacitance of a human body. When the user touches the touch sensor 102, the static electricity flows in through the touch sensor 102 and the touch detecting section 320 is operated by the static electricity flown from the human body so that it can be detected whether or not the touch sensor 102 is touched.

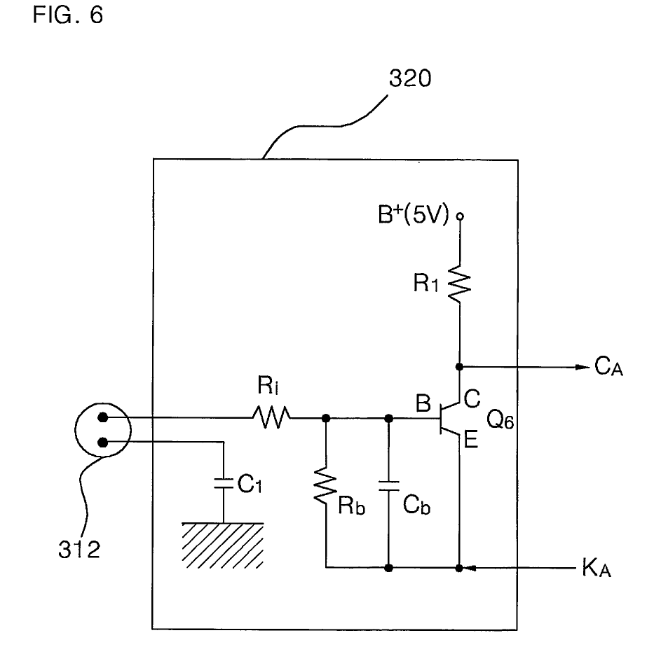

In other words, as shown in FIG. 6, the touch sensor 102 has one end connected to a kind of a human body capacitor and the other end connected to the input resistor of the touch detecting section 320. FIG. 6 shows a touch sensor 312 and a touch detecting section 320 connected to the touch sensor 312. The touch detecting section 320 includes one switching transistor. Accordingly, when the user touches the touch sensor 312, the touch sensor 312 becomes conductive by the user and the static electricity of the user's body is charged in the human body capacitor. As a result, the touch sensor 312 functions as a bridge allowing the user to turn the transistor on/off. On the other hand, a transistor is turned on by the static electricity charged in the human body capacitor to output a predetermined sensing signal through a collector.

The password input unit 300 can further include: a sensing signal transfer section 330 for providing the door operation unit 400 with the sensing signal generated by the touch detecting section 320; a password input start section 340 for releasing a sleep mode set so as to save a battery and allowing the password to be inputted; and a door opening/closing ascertaining section 350 for ascertaining whether the door is opened or closed. Here, it is desired that the password input start section 340 is the password input start button 104 of FIG. 1 and the door opening/closing ascertaining section 350 is the door opening/closing ascertaining button 106 of FIG. 1. Accordingly, as soon as a user presses the password input start button 104, the generated signal is provided to a control section 440 of the door operation unit 400 and the sleep mode is released by the control section 440, so that the user can input the password.

In addition, when the user presses the door opening/closing ascertaining button 106, the control section 440 operates a sound output section 480 using the generated signal, thus generating a predetermined sound that informs the user of whether the door is opened or closed.

Meanwhile, the door operation unit 400 includes: a control section 440 for determining whether or not the previously set password match the sensing signal supplied from the password input unit 300 and controlling the opening/closing of the door according to the determining result; a signal processor section 420 for outputting an output signal to ascertain whether or not the user touches based on the sensing signal and a key signal outputted from the control section 440; and a door opening/closing driving section 450 for driving the door to be opened and closed by the control section 440. Here, it is desired that the control section 440 has a port (not shown) for determining which touch sensor among the plurality of touch sensors the sensing signal outputted from the touch detecting section 320 is generated from.

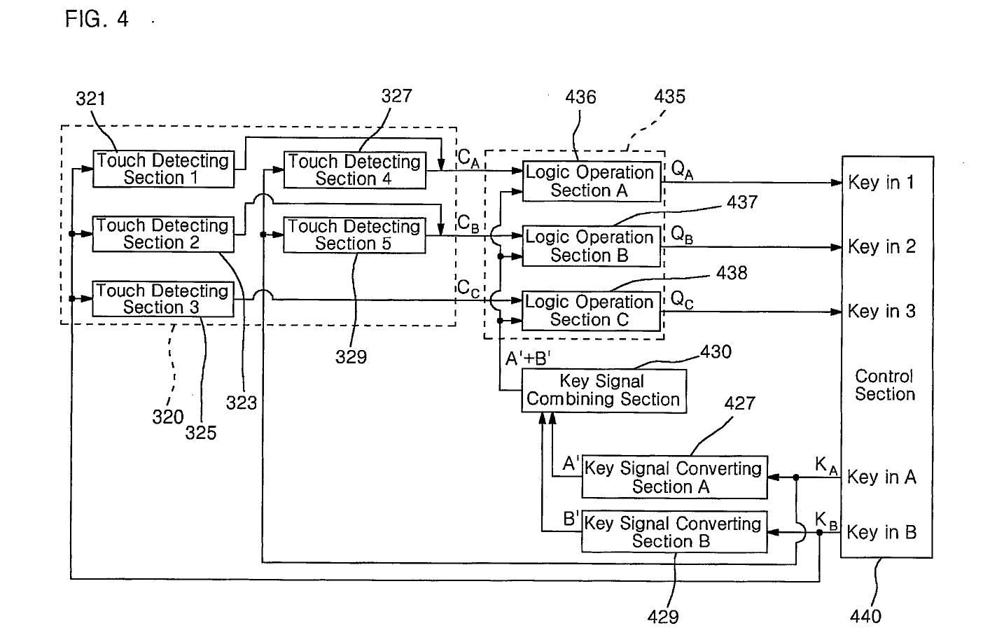

Describing that in detail with reference to FIG. 4, the touch detecting section 320 has a plurality of touch detecting sections 321 to 329 corresponding to five touch sensors. The control section 440 outputs two key signals K_{A} and K_{B} to determine whether or not the user touches. The two key signals K_{A} and K_{B} can be inputted to key signal converting sections 427 and 429 or the plurality of touch detecting sections 321 to 329.

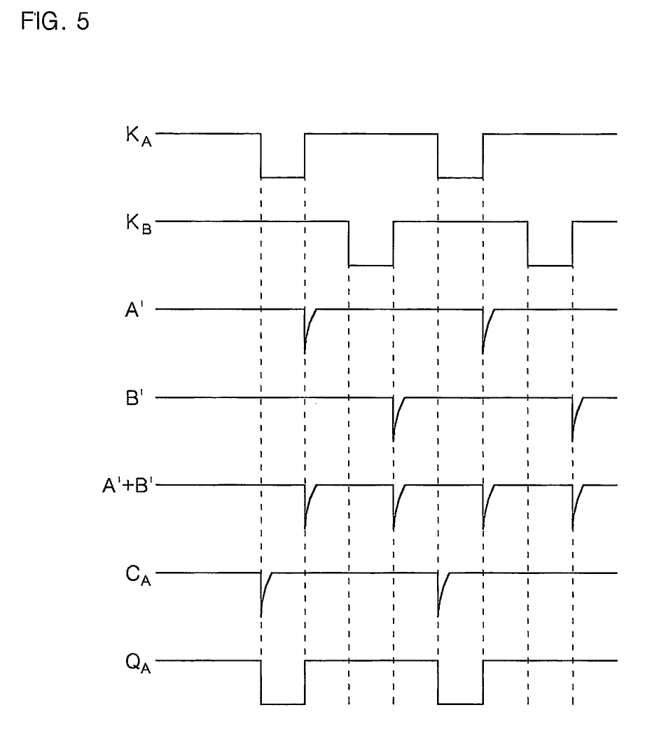

The key signal converting sections 427 and 429 converts the inputted key signals to output an impulse signal A′ or B′ as shown in FIG. 5. The impulse signals A′ and B′ outputted from the key signal converting sections 427 and 429 are combined with each other to be a combined signal A′+B′ by a key signal combining section 430. The combined signal A′+B′ is inputted to a logic operation section 435. The logic operation section 435 includes three logic operation sections 436, 437 and 438. The logic operation sections 436, 437 and 438 perform logic operation based on the sensing signals C_{A}, C_{B} and C_{C} inputted from the touch detecting section 320 and the combined signal A′+B′ inputted from the key signal combining section 430, and provides the output signals to the control section 440.

The waveforms of the respective signals are shown in FIG. 5. As shown in FIG. 5, the key signals K_{A} and K_{B} outputted from the control section 440 and the output signal Q_{A} of the logic operation section 435 are square waves and the signals A′ and B′ outputted from the key signal converting section 425 and the sensing signal CA outputted from the touch detecting section 320 are impulses. Accordingly, when the sensing signal C_{A} is inputted from the touch detecting section 320 to the logic operation section 435 based on the key signals outputted from the control section 440, the control section 440 can detects whether or not the user touches using the output signal Q_{A} outputted from the logic operation section 435.

Meanwhile, as shown in FIG. 6, some of the key signals K_{A} and K_{B} outputted from the control section 440 are inputted to an emitter of a transistor to determine whether or not the user touches. In other words, the position where the pulse K_{A} of the key signal is changed from 1 to 0 can be the position where the sensing signal C_{A} is outputted through a collector of the transistor due to the user's touch. The pulse of the sensing signal C_{A} is inputted to the logic operation section 435 to change the output signal Q_{A} from 1 to 0.

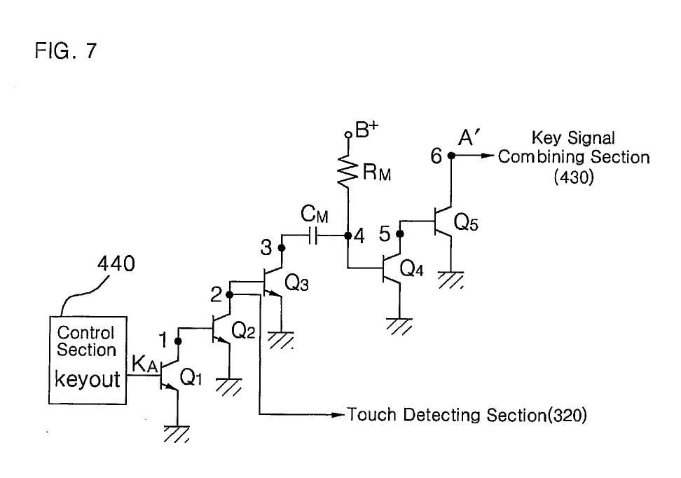

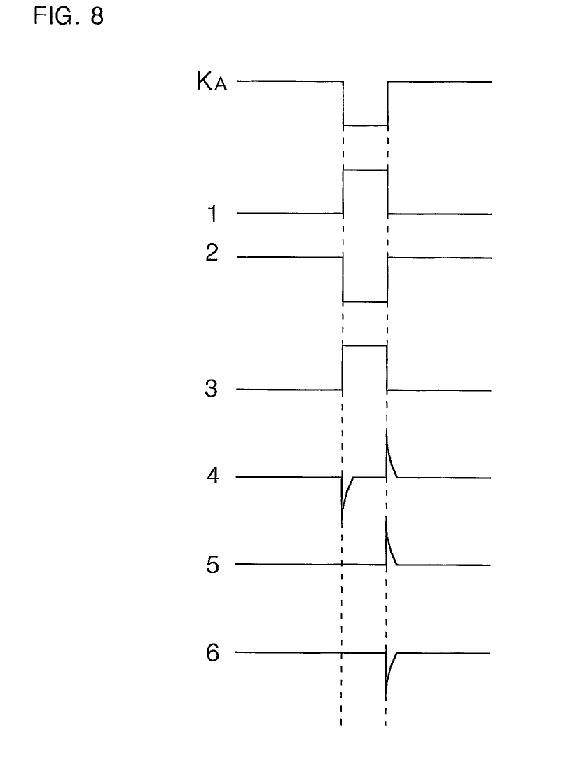

The key converting section 425 includes five transistors and a differential circuit as shown in FIGS. 7 and 8. The key signal converting section 425 shown in FIGS. 7 and 8 is one of two key signal converting sections 427 and 429 that receive key signals KA and KB outputted from the control section 440, respectively.

The square wave key signal K_{A} outputted from the control section 440 is inverted in phase by a first transistor Q1 (location 1). The inverted square wave key signal is inverted again by a second transistor Q2 (location 2) and inputted to a touch detecting section 320. Some portion of the signal is inputted to a third transistor Q3 and inverted again (location 3). The square wave key signal inverted by the third transistor Q3 is converted into 2 impulses (up impulse and down impulse) by differential circuits R_{M} and C_{M} (location 4). The two impulses are clamped by a fourth transistor Q4 and only the up impulse remains (location 5). The up impulse is inverted by a fifth transistor Q5 again (location 6) and inputted to a key signal combining section 430.

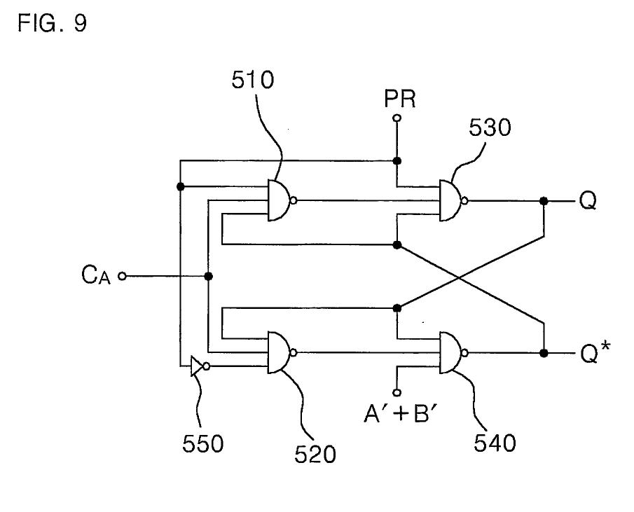

FIG. 9 illustrates a logic operation section shown in FIG. 3. Referring to FIG. 9, the logic operation section 435 includes four NAND gates 510, 520, 530 and 540 and one inverter 550. The logic operation section 435 receives the sensing signal C_{A} generated by the touch detecting section 320, the combined key signal A′+B′ generated by the key signal combining section 430, and a set signal PR and performs a logic operation with respect to the signals. The result Q of the logic operation is inputted to the control section 440. The input/output of the logic operation section will be described with reference to the following Tables 1 and 2.

TABLE 1

| | |
|---|---|
| Input | Output |

| PR | A′ + B′ | C | QN + 1 | QN | Q*N |
|---|---|---|---|---|---|
| L | H | X | X | H | L |
| H | L | X | X | L | H |
| L | L | X | X | H | H |

TABLE 2

| | |
|---|---|
| Input | Output |

| PR | A′ + B′ | C | QN + 1 | QN | Q*N |
|---|---|---|---|---|---|
| H | H | | L | L | H |
| H | H | | H | H | L |

As shown in Tables 1 and 2, in the logic operation section, if PR=0 and A′+B′=1, then Q=1. If PR=1 and A′+B′=0, then Q=0. If PR=0 and A′+B′=0, then Q=indefinite. If PR=1 and A′+B′=1, Q depends on C. In other words, if Q is changed from 0 to 1, Q is changed from 1 to 0.

Referring again to FIG. 3, the control section 440 generates a password key based on the sensing signals inputted from a password input unit 300 and compares the password with a previously set password to determine whether or not the password accords with the previously set password. If the password accords with the deliberately set password, the control signal is inputted to a door opening/closing driving section 450 to open the door.

In addition, the control section 440 releases the sleep mode in response to the password input start section to allow a password to be inputted. The control section 440 ascertains whether the door is opened or closed in response to the door opening/closing ascertaining section 350 and reports the result through a sound output section 480. The control section 440 controls the door to be opened or closed electronically in response to an electronic door opening/closing section 475.

Meanwhile, the door operation unit 400 can further include: a password mode selection section 485 for selecting a password mode; a door opening/closing operation section 460 operated by the door opening/closing driving section 450; and a manual door opening/closing section 490 for operating the door opening/closing operation section 460 manually to open and close the door. Here, the electronic door opening/closing section 475 is the door opening/closing buttons 202A and 202B shown in FIG. 1. The manual door opening/closing section 490 is the manual door opening/closing member 214 shown in FIG. 1. The door opening/closing operation section 460 is a door opening/closing operation member 212.

In addition, the door operation unit 400 can further include a storage section 470 for storing the password that the user has set, and a sound output section 480 for acoustically informing the user of operation states according to the control of the control section 440.

The operation of the apparatus for opening/closing the door configured as described above will be described.

Here, although the description about the process of setting a password according to the present invention will be limited to consonants and vowels of Korean, it should be noted that the process of setting a password can be applied to numbers, special characters, English, etc.

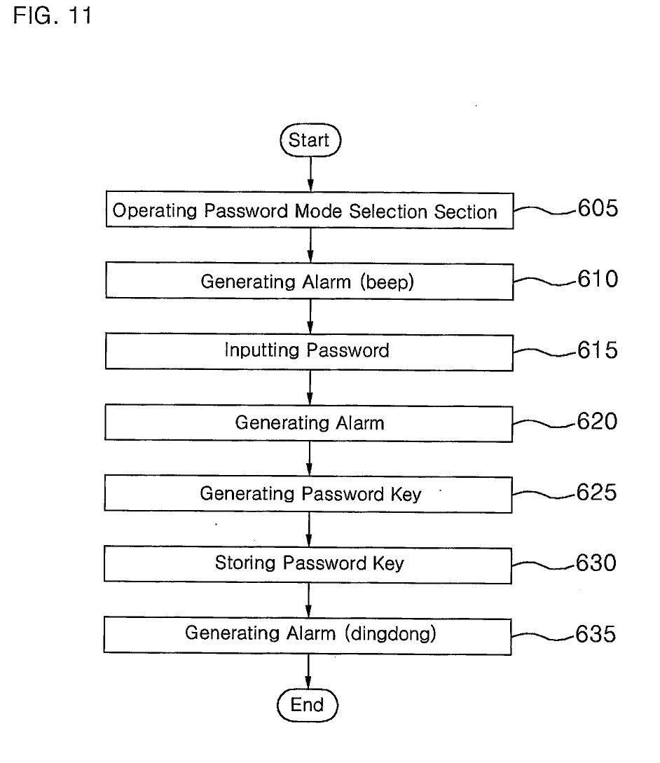

The method in which a user sets the password the user will use will be described with reference to FIG. 11. FIG. 11 is a flowchart illustrating a method of registering a password to the apparatus for opening/closing a door according to a preferred embodiment of the present invention. Referring to FIG. 11, the user can select a password mode to set a password (step 605). At this time, the user can set the password differently by pressing the password mode selection buttons 204A and 204B. In other words, as shown in FIG. 11, if the user presses the left password mode selection button 204A among the password mode selection buttons 204A and 204B, the user can input a sentence or the like when setting the password. On the contrary, if the user presses the right password mode selection button 204B among the password mode selection buttons 204A and 204B, the user can input a syllable, a word or the like instead of a sentence.

However, it should be noted that the password patterns to be inputted according to the pressed password mode selection buttons 204A and 204B are not defined previously but the password patterns can be defined differently.

When the user selects a password mode, a predetermined alarm sound is outputted through the sound output section 480 and the inputting of password is allowed (step 610).

Here, in order to input a password, the user inputs the password through the five touch sensors 102 for sensing the touches of fingers, which is installed in the outdoor apparatus shown in FIG. 1. The process of inputting the password will be described below in detail.

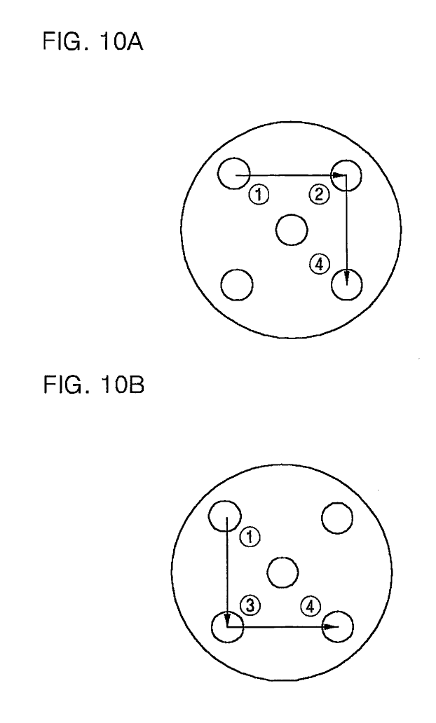

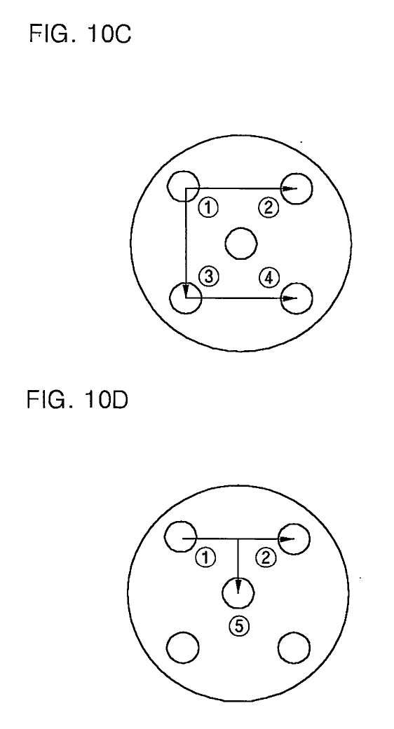

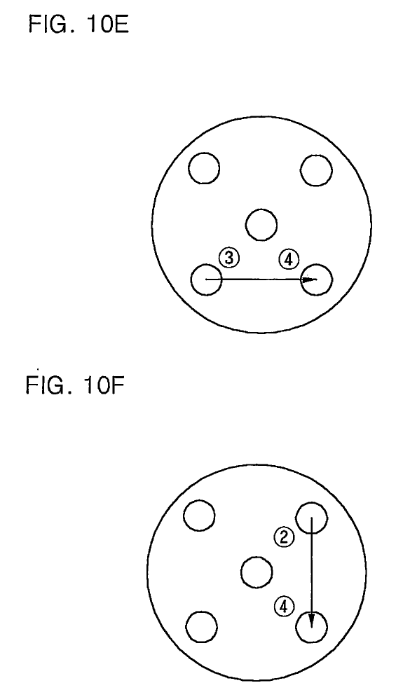

FIGS. 10A to 10F illustrate input order of characters and numbers. In FIGS. 10A to 10F, the numbers on the touch sensors are not recognized by the control section 440 of the door operation unit 400 but used for convenience. The control section 440 of the door operation unit recognizes only touch order of the touch sensor touched by a finger. For this purpose, ports corresponding to touch sensors are installed in input terminals of the control section 440. These ports are used to recognize the touch order.

As shown in FIG. 10a, when inputting ‘ [symbol] ’ of Korean consonants, the touch sensors 1, 2 and 4 are touched in that order of the touch sensors 1, 2 and 4 according to a general order. Accordingly, the touch detecting section senses each of the touched touch sensors and generates a sensing signal. The generated sensing signal is transferred to the signal processing section through the transfer section (step 615).

At this time, after inputting ‘ [symbol] ’, a predetermined alarm sound (for example, beep) is outputted from the sound output section 480 to inform the user that the password is inputted normally (step 620).

When the user wants to input another consonant or vowel after ‘ [symbol] ’ is inputted, the touch sensor corresponding the desired consonant or vowel is successively touched in the above-mentioned method. For instance, when the user wants to input ‘ [symbol] ’ as shown in FIG. 10b, the touch sensors 1, 3 and 4 are touched successively. As shown FIG. 10c, in case of ‘ [symbol] ’, the touch sensors 1, 2, 3 and 4 are touched successively. In addition, if the touch sensors are used properly, ‘T’, ‘-’ and ‘ [symbol] ’ can be inputted as shown in FIGS. 10d to 10f.

For example, when the user would like to set [symbol] (which means “thanks” in Korean) as a password, the touch sensors 1, 2, 4 ( [symbol] ), 1, 3, 5 ( [symbol] ), 1, 2, 3, 4 ( [symbol] ), 2, 5, 3 ( [symbol] ), 1, 3 and 5 ( [symbol] ) are pressed successively to thereby set the word ‘ [symbol] ’ as the password. Of course, the control section recognizes the password ‘ [symbol] ’ as the order (password key) of 1, 2, 4, 1, 3, 5, 1, 2, 3, 4, 2, 5, 3, 1, 3 and 5. Accordingly, if any one in the order is changed, the door will never open.

If the user sets the password as above and tries to open the door using the password, the touch sensors should be touched in that order so as to open the door. For this purpose, if the user only memorizes the word ‘ [symbol] ’, the user can open the door by touching the touch sensors as writing the password in the user's writing habit since writing order depends on writing habit.

By touching the touch sensors successively as writing the desired word or sentence in the above-mention manner, the user can input the desired word or sentence.

In this way, when terminating after all the password is inputted, the user does not input any longer and the password is automatically set by the control section. In other words, if the user does not input the password any more, the control section 440 continues to check the sensing signal from the password input unit 300 and does not receive the sensing signal for a predetermined time or longer. Then, the control section 440 regards this as a password setting termination and generates a password key using the password that the user has inputted until now (step 625). The control section 440 stores the generated password key in a storage section 470 (step 630) and outputs alarm sound (for example, dingdong) through the sound output section 480 (step 635). Also, the storage and setting of the password can be terminated by pressing the password mode selection section 485

On the other hand, when the password is set in the above-mentioned method and the user tries to ascertain whether the door is opened or closed using the stored set password, the user inputs the stored set password through the touch sensors 102 and presses a door opening/closing ascertaining button 106. Then, if the door is opened, the password was inputted normally. On the contrary, if the door is not opened, the inputted password is not valid and the password should be inputted again. The door opening/closing ascertain button is pressed to ascertain whether or not the door is closed normally.

Since a plurality of passwords can be set according to the above-mentioned process, the members of a family can store and have different passwords.

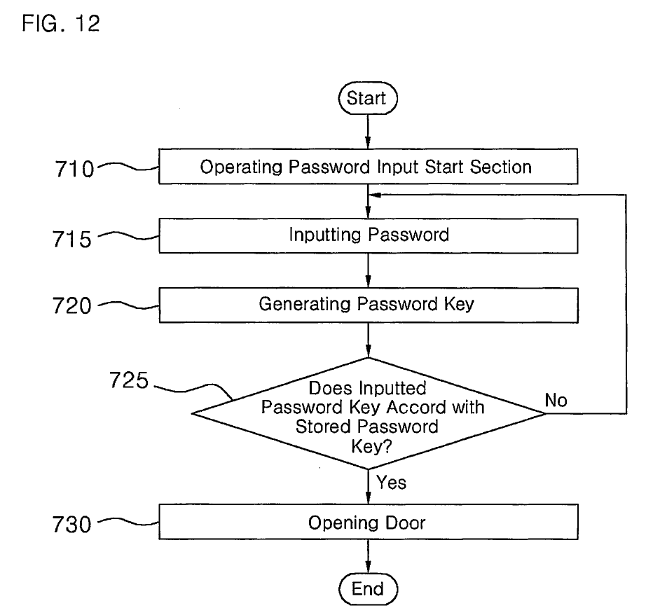

Hereinafter, an opening/closing operation of a door in a state that the password setting is completed will be described with reference to FIG. 12.

First, in order to input the password key that the user has set and registered for opening a door at an outside of the door, the user informs the control section 440 of the door operation unit that the password is ready to input through a password input start section 340 installed in a password input unit, which is disposed outside the door (step 710). Then, the control section 440 releases the mode based on the signal inputted from the password input start section 340 and informs the user that the password is ready to input through the sound output section 480.

The user who is ready to input the password inputs the password by fingers through the five touch sensors 102 (step 715).

As described above, if the previously set and registered password is ‘ [symbol] ’, the user inputs the password ‘ [symbol] ’, by touching the five touch sensors positioned at predetermined locations one by one. In other words, ‘ [symbol] ’, consists of ‘ [symbol] ’, ‘ [symbol] ’, ‘ [symbol] ’, ‘ [symbol] ’ and ‘ [symbol] ’, which are consonants and vowels of Korean. Accordingly, the touch sensors 1, 2 and 4 are pressed successively so as to input ‘ [symbol] ’. The touch sensors 1, 3 and 5 are pressed successively so as to input ‘ [symbol] ’. As the same way, the touch sensors 1, 2, 3 and 4 are pressed successively so as to input ‘ [symbol] ’. The touch sensors 2, 5 and 3 are pressed successively so as to input ‘ [symbol] ’. The touch sensors 1, 3 and 5 are pressed successively so as to input ‘ [symbol] ’. So, the desired password is inputted. Accordingly, the user should press the touch sensors 1, 2, 4, 1, 3, 5, 1, 2, 3, 4, 2, 5, 3, 1, 3 and 5 successively without any stop when inputting the password ‘ [symbol] ’. Therefore, the user presses the touch sensors seventeen times at total. Of course, the password which was set and registered by the user was registered by successively touching the touch sensors which are positioned at the same locations described above. Here, whenever each of consonants and vowels is inputted, the control section can output a predetermined alarm (for example, beep).

When the touch sensors are touched, a touch detecting section 320 senses that the touch sensors are touched and a predetermined signal (for example, a sensing signal) is outputted to the signal processing section 420.

The signal processing section 420 receives the sensing signal C and a combined key signal A‘+B’ outputted from the control section 440 and performs a logic operation with respect to the signals. The output signal Q is inputted to the control section 440. Here, the combined key signal A′+B′ is a signal generated by combining the two key signals (A′ and B′) outputted from the control section 440. The combined key signal A′+B′ prevents malfunction from occurring when the user touches the touch sensors and the output signal of the signal processing section 420 is changed from ‘1’ to ‘0’. In other words, if the prior output signal is kept to be the same during the period when the next key signal is generated, the output signal of the signal processing section 420 is changed from ‘0’ to ‘1’ due to the combined key signal.

Accordingly, the signal processing section 420 performs a logic operation with respect to the sensing signal C inputted from the touch detecting section 320 and the combined key signal A′+B′ outputted from the control section 440 and combined, and then generates the output a signal Q.

The control section 440 receives successively the output signal outputted from the signal processing section 420 to generate a password key (step 720).

In other words, when the user touches any one of the touch sensors 102 to input a password, the sensing signal outputted from the touch detecting section 320 is processed by the signal processing section 420 and inputted to the control section 440. When the user inputs all the words or sentences that are set and registered as a password, the corresponding sensing signals are inputted to the control section 440 successively. Accordingly, the control section 440 receives successively the output signals outputted from the signal processing section 420 and arranges the received signals in received order to thereby generate a password key.

The control section that generated the password key using the password inputted from the user retrieves the password key that has been set and registered, and determines whether or not the generated password key accords with the set and registered password key in arrangement order and number of the password (step 725).

As the determining result, if any one of the arrangement order or the number of the password does not accord, the control section informs the user that the password does not accord by outputting alarm or the like. At this time, the user can input the password again. However, unless the password is valid in predetermined times, the control section prevent password from being inputted any more and the door does not open.

As the determining result, if the generated password key accords with the set and registered password key, the control section 440 controls the door to open (step 730).

In other words, according to the accord of the password key, the control section 440 generates a control signal to drive the driving motor 210A. Accordingly, as the link member 210B connected to the driving motor 210A rotates, the door opening/closing operation member 212 slides in a direction to open the door.

Meanwhile, when the user locks the door outside of the door to go out, any one of the five touch sensors is touched to close the door with outputting an alarm ‘dingdong’.

When the user opens and closes the door at an inside of the door, the door opening/closing buttons 202A and 202B are touched to easily open and close the door. At this time, in order that the door is not opened easily, the door opening/closing buttons are pressed for two seconds or more to close the door with an alarm when closing the door. If so, the door is not opened even though the door opening/closing buttons 202A and 202B are pressed. Of course, if the user tries to open the door, the user can open the door by pressing the door opening/closing buttons for two seconds or longer. Also, the user can open and close the door forcedly using the manual door opening/closing section 214.

### INDUSTRIAL APPLICABILITY

As described above, if the consonants and vowels of Korean consisting of 28 characters are combined, more than 1,800,005,000 Korean letters are made. Further more, considering English alphabets, numbers and special characters, almost unlimited passwords can be generated.

The user combines the unlimited characters to register and change the password.

Also, even when consonants and vowels of Korean are combined to form a predetermined words and letters, the passwords can be generated differently according to the personal writing patterns, that is, writing order. Accordingly, the more efficient password patterns can be achieved than the conventional apparatus for opening/closing a door.

In the apparatus for opening/closing a door according to the present invention, since English alphabet, special characters and numbers as well as Korean Hangeul can be used, the application of the present invention can be maximized.

In the present invention, since the door is opened and closed using the password in the character shape, the password can be inputted in the form of characters and the present invention provides the users with passwords that is easy to memorize. Furthermore, the password verification can be systematized much more, thereby providing safer security reliability.

In addition, the apparatus for opening/closing a door according to the present invention can be applied to an entrance, a safe, vehicle, etc., as well as a door.

Further, the method of setting a password by inputting Korean Hangeul or English alphabet according to the present invention can be applied to a mobile communication terminal or the like.

Even though the description was bounded to the apparatus for opening/closing a door according to the present invention, the modifications and variations of this invention come within the scope of the appended claims and their equivalents since the application of the present invention is very wide as described above.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents.

1. An apparatus for opening/closing a door, the apparatus comprising:
sensing means for sensing a password inputted by a user and outputting a sensing signal;
controlling means for determining validity of the password based on the sensing signal and outputting a control signal according to a determining result; and
door opening/closing means for opening/closing the door according to the control signal.

2. The apparatus according to claim 1, further comprising signal processing means for processing the sensing signal using a key signal outputted from the controlling means so that the sensing signal is normally outputted without any malfunction.

3. The apparatus according to claim 2, wherein the signal processing means comprises:
a key signal converting section for differentiating the key signal outputted from the controlling means and outputting an impulse signal;
a key signal combining section for combining the impulse signal and another impulse signal and outputting a combined signal; and
a logic operation section for performing logic operation using the combined key signal so that the sensing signal is outputted normally without any malfunction.

4. The apparatus according to claim 3, wherein when the sensing signal remains in a previous state during a period of a next key signal outputted from the controlling means, the impulse signal switches the sensing signal.

5. The apparatus according to claim 2, wherein some of the key signal outputted from the controlling means is inputted to the sensing means and used to ascertain whether or not the user inputs the password.

6. The apparatus according to claim 1, further comprising:
password input start means for releasing a sleep mode before the user inputs the password so that the password is inputted normally; and
door opening/closing ascertaining means for ascertaining whether or not the password is set normally after the password is set.

7. The apparatus according to claim 1, further comprising:
sound output means for reporting to the user acoustically whether or not the password is inputted and set normally; and
storage means for storing the set password used to determine whether or not the password is set and inputted by the user normally.

8. The apparatus according to claim 1, further comprising:
password mode selection means for selecting a mode of the password which the user should input so as to set the password; and
electronic door opening/closing means for allowing the user to open and close the door inside the door.

9. The apparatus according to claim 1, wherein the sensing means comprises:
a plurality of touch sensors arranged at predetermined positions, for inputting or setting the password by a user's touch; and
a touch detecting section correspondingly connected to the plurality of touch sensors, for sensing a touch of the user and outputting a corresponding sensing signal.

10. The apparatus according to claim 9, wherein the touch sensors become conductive through a medium of human being when the human being touches the touch sensors.

11. The apparatus according to claim 9, wherein the touch detecting section senses whether or not the human being touches the touch sensors using a static capacitance of the human body when the human being touches the touch sensors.

12. The apparatus according to claim 1, wherein the door opening/closing means comprises:
a door opening/closing driving section for driving a driving motor according to the control signal outputted from the controlling means and rotating a link member connected to the driving motor; and
a door opening/closing operation section connected to the link member, and slidingly moving in a direction according to a rotation of the link member.

13. The apparatus according to claim 1, wherein the validity of the passwords is determined using an arrangement order of the passwords.

14. The apparatus according to claim 13, wherein the validity of the password is determined by number of the password.

15. The apparatus according to claim 1, wherein the controlling means comprises a port for determining which touch sensor of a plurality of touch sensors included in the sensing means outputs the sensing signal.

16. A method of opening/closing a door, the method comprising the steps of:
(a) sensing a password inputted by a user and outputting a sensing signal;
(b) determining validity of the password based on the sensing signal and outputting a control signal according to a determining result; and
(c) opening the door according to the control signal.

17. The method according to claim 16, wherein the step (a) comprises the steps of:
(a-1) releasing a sleep mode by using password input start means;
(a-2) allowing the user to touch a plurality of touch sensors so as to input the password using the plurality of touch sensors arranged at predetermined positions; and
(a-3) generating a sensing signal in response to the touch of the plurality of touch sensors.

18. The method according to claim 17, wherein the sensing signal is generated by using static capacitance stored in a human body as a source.

19. The method according to claim 16, wherein the step (b) comprises the steps of:
(b-1) receiving at least one sensing signal generated when the user touches the touch sensors;
(b-2) arranging at least one sensing signal in an input order and generating a password key;
(b-3) determining whether or not the password key accords with a previously set password key; and
(b-4) when the password key accords with the previously set password key, outputting a control signal for controlling the door.

20. The method according to claim 19, wherein the step (b) further comprises the step of: (b-5) processing the at least one sensing signal using a key signal so as to prevent the at least one sensing signal from malfunctioning.

21. The method according to claim 20, wherein the key signal is outputted from the controlling means.

22. The method according to claim 19, wherein the step (b-3) is performed based on arrangement order and number of the sensing signals.

23. The method according to claim 16, wherein the step (c) comprises the steps of:
(c-1) driving a driving motor according to the control signal;
(c-2) rotating a link member in response to a driving of the driving motor; and
(c-3) slidingly moving a door opening/closing operation section connected to the link member in a direction according to a rotation of the link member.
